(19) United States
(12) Patent Application Publication
(10) Pub. No.: US 2025/0276879 A1
(43) Pub. Date: Sep. 4, 2025

(54) Control circuitry for a crane, crane, remote control unit for a crane and method to operate a crane

(71) Applicant: Palfinger AG, Bergheim bei Salzburg (AT)

(72) Inventors: Andreas TIEFENTHALER, St. Lorenz (AT); Gerald RIESS, Gurten (AT); Ewald MATHÉ, Elixhausen (AT); Hannes KRANZINGER, Koestendorf (AT); Daniel THOENY, Thalgau (AT)

(21) Appl. No.: 18/592,879

(22) Filed: Mar. 1, 2024

(51) Int. Cl. B66C 13/48; B66C 13/40; B66C 23/16; B66C 23/66; B66C 23/70

(52) U.S. Cl. CPC B66C 13/48; B66C 23/166; B66C 23/66; B66C 23/701; B66C 13/40

(57) ABSTRACT

Control circuitry for a crane, comprises an input interface (102) configured to receive readings of sensors (174, 520) sensing operating parameters of the crane and an output interface (104) to output control data to cause actuators of the crane to perform a movement. A compute circuit (106) is configured to control the movement of the actuators in a first operation mode and in a second operation mode, wherein at least one kinematic parameter of the actuators is limited in the second mode as compared to the first mode.

### FIELD

The present disclosure relates to control of cranes and to the use of different attachments at a crane.

### Background

In different scenarios, cranes may be additionally equipped with different attachments, the attachments adding additional functionality. Different attachments may require different restrictions on some or all of the kinematic parameters of the crane. For example, some attachments may allow fast movement of the crane while others require a slower movement of at least some components of the crane, such as for example a slower rotation of the column. The crane, therefore, has to be delivered with its kinematic parameters limited to the attachment with the most restrictive demands. However, if new attachments are developed later that have again more restrictive demands, the cranes delivered until the development cannot be used together with the new attachments.

There may be a demand to add more flexibility to cranes.

### BRIEF DESCRIPTION OF THE FIGURES

Some examples of apparatuses and/or methods will be described in the following by way of example only, and with reference to the accompanying figures, in which

FIG. 1 schematically illustrates an example of control circuitry for a crane and a crane;

FIG. 2 illustrates an example of a crane having attached thereto a workman basket;

FIG. 3 illustrates an example for a mounting interface for mounting a workman basket to the boom system;

FIG. 4 illustrates an example for an adapter for the workman basket attached to the mounting interface;

FIG. 5 illustrates an example of a column of a crane;

FIG. 6 illustrates an overview of components involved in operating a crane; and

FIG. 7 illustrates a flowchart of an example of a method to operate a crane.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

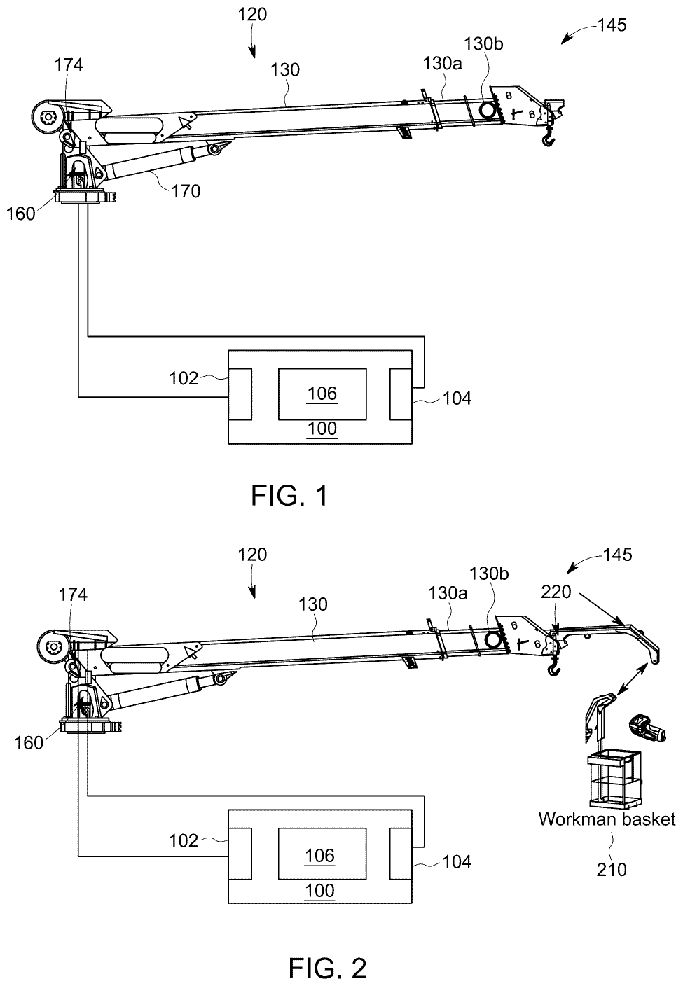

FIG. 1 schematically illustrates an example of control circuitry 100 for a crane together with an exemplary crane 120 having a single boom 130.

Generally speaking, a crane comprises a boom system mounted to a column of the crane. The column is rotatable with respect to a base of the crane. In some examples, the axis of rotation of the column may be a substantially vertical axis. The angle of rotation about the axis of rotation may be referred to as the slew angle or slewing angle.

The base can be configured to mount the crane onto a platform. The platform may be a fixed platform or a mobile platform. Examples of mobile platforms are vehicles such as trucks, lorries or ships. The boom system can be rotated or moved relative to the column about an axis (e.g. a boom axis) that is essentially perpendicular to the axis of the rotation of the column. The angle of the rotation of the boom system about the boom axis may be referred to as an elevation angle.

Hydraulic cylinders may be used as actuators to create the force to cause the rotation or motation of the boom system with respect to the elevation angle. A boom system comprises at least one (or e.g. one or more booms). In the event of a plurality of booms (e.g. more than one boom), the boom attached to the column may be referred to as the main boom or first boom. Additionally, a second boom attached to the main boom may be referred to as a knuckle boom. Any (or each) of the booms of a boom system can optionally comprise one or more extension booms to be driven in or out of the boom using, for example, hydraulic means. A boom and its extension booms may also be called a boom subsystem.

Cranes having only one boom may also be called stiff boom cranes since they do not exhibit multiple booms that can change their orientation with respect to each other. In the event of cranes having multiple booms, a knuckle can be used to connect the different booms to one another so as to enable them to change their relative orientation, by bending or buckling about an axis defined by the knuckle.

In some examples, a crane may comprise a bendable boom system connected to the crane column. A bendable boom system may comprise a first boom, wherein a first end of the first boom is connected to the crane column. The bendable boom system may further comprise a second boom, wherein the second boom is connected to a second end of the first boom. Cranes having at least two booms connected by a knuckle or hinge offer an additional degree of freedom as compared to stiff boom cranes and may be called knuckle-boom cranes. The booms can be connected by hydraulic cylinders across the knuckle to cause the rotation.

The free end of the boom system not attached to the column may be referred to as the tip of the boom system. Loads may be directly attached to the tip of the boom system. However, cranes may additionally comprise at least one winch mounted to the boom system or elsewhere to the crane, the winch being used to wind und unwind a cable carrying the load. The tip of the boom system may exhibit a wheel for the cable. The cable extends to a load block used to attach the load thereto. In a single wire operation (also called STRAN1) the cable ends in the load block. The cable of the winch may also be used according to the principles of a pulley. If this is the case, the load block exhibits at least one pulley to change the direction of the cable and the cable ends at the boom system, typically close to the tip of the boom system. In the event of a single pulley, operation is also called two wire operation (STRAN2). Of course, multiple pulleys may be used likewise for multi wire operation.

Movement of the crane is caused by using multiple types of actuators such as hydraulic engines, valves and cylinders to cause motion of the booms and electric engines used to cause motion of the column or to operate the winch. Components used to cause movement of the crane or of parts of the crane are called actuators. The movement of the crane is monitored by means of multiple sensors, providing sensors readings indicative of multiple parameters or physical quantities. For example, pressure sensors may be used to monitor the pressure within hydraulic cylinders to determine the forces acting on them. Angle sensors may be used to monitor relative rotation or angle between different parts of the crane (e.g. between the column and the base or between different boom of a knuckle boom crane). Angle sensors may, for example use an encoder wheel together with a sensor sensitive to magnetic fields. Length sensors may be used to monitor the overall length of a boom and its associated extensions. Force sensors may be used to measure force directly or indirectly, for example to measure the force acting on the cable of a winch and/or on the winch itself. Force sensors may, for example, be based on the piezo electric effect or using strain gauges attached to the object being monitored.

The movement of the crane may be controlled by a crane controller that outputs control signals to cause the actuators of the crane to perform an operation. Likewise, the crane controller receives sensor readings to monitor the result of the actuators operation. In some examples, the crane controller may be an integral part of the crane. The desired movement of the crane is typically performed or controlled based on or following a user input. The user input may be manually given by a human operator or supervisor of the crane or it may likewise be generated automatically based on an algorithm or on input parameters generated by other means, such as for example by a trained neural network. For manual input, the crane may exhibit a crane mounted input device (operating panel) having, for example, one or more levers or joysticks to control motion as well as a user interface to input or change user settings and/or crane parameters such as for example different modes of operation of the crane. The input device communicates with the crane controller that transforms the user input into the actuator operations required to result with the desired movement as per the input via the input device. Additionally or alternatively, parts of or all inputs that can be performed using the input device may also be performed using a remote control unit wirelessly communicating with the crane controller.

A crane may be used for multiple purposes by providing the possibility to exchange equipment mounted at the booms of the crane. For example, multiple different attachments can be mounted to the booms close to the tip of the boom system. To support this, the crane may provide a mounting interface close to the tip of the crane. A mounting interface may be composed of multiple elements, mounted to or welded at a boom. Eventually, equipment such as a workmen basket may be mounted to the mounting interface via an adaptor used to adapt the (standard) mounting interface of the crane to a custom mounting interface of the equipment to be used.

In the illustration of FIG. 1, the illustrated crane 120 is a stiff boom crane. Control circuitry and methods to operate a crane as disclosed herein may, however, likewise be used together with knuckle boom cranes.

The control circuitry 100 comprises an input interface 102 configured to receive readings of sensors sensing operating parameters of the crane.

For example, an angle sensor 174 may be used to monitor the elevation angle between the boom 130 and the column 160. The elevation angle is just an example for further or different boom angle parameters of a crane that may be used as sensor readings in other examples of control circuits 100. In this example, the elevation angle is a boom angle parameter determined based on an angle between a main boom 130 of the crane and the column 160. In further examples using knuckle boom cranes, the boom angle parameter may additionally or alternatively be determined based on an angle between a further boom and the main boom. Furthermore, another parameter used may be a length extension parameter measured by a boom extension sensor. The length extension parameter indicated the present length of the boom 130 that depends on the extent the boom extensions 130a, 130b are driven out.

An output interface 104 is configured to output control data to cause actuators of the crane to cause a motion of at least one of a boom 130 of a boom system or a column 160 of the crane. Actuators controlled may, for example, be hydraulic pumps or valves used to operate hydraulic cylinder 170 to change the elevation angle or to operate further hydraulics to cause the extension booms 130a, 130b being driven out. Likewise, electric motors may be another type of actuators used to control a rotation of the column 160.

The control circuitry 100 further comprises a compute circuit 106 that is configured to control the movement of the actuators in a first operation mode and in a second operation mode. In the second mode, at least one kinematic parameter of the actuators is limited as compared to the first mode.

This may allow to automatically consider loads, attachments or other use cases of a crane that require more cautious movement of the crane, be it for technical reasons, for security reasons or by law.

For example, a workman basket 210 may be attached to the tip 145 of the crane 120 as illustrated in FIG. 2. In this event, it may be required by law that acceleration or deceleration or a maximum speed of the movement of the crane or a combination of those parameters is limited to prevent people in the workman basket from feeling uncomfortable or from even falling out.

Hence, according to some examples, the at least one kinematic parameter comprises at least one of a maximum speed, a reference acceleration, a reference deceleration, a maximum extension, a maximum rotation, a lifting capacity and a functionality. In the event of a workman basket attached, a functionality that can be limited, is, for example, the operation of a winch arrangement of the crane in order to avoid accidental lowering of a load block towards the workman basket.

In the event of limiting a maximum speed, a net speed resulting from the simultaneous movement caused by multiple actuators may be limited. According to further examples, a functionality may be limited such that only one actuator at a time can be moved and that the speed of ever actuator is limited individually.

Furthermore, some use cases may require to limit a maximum load allowed to be lifted by the crane in the second mode as compared to the first mode. For example, if the second mode is associated to the use of a workman basket, safety margins may be required to be higher as compared to a use in the first mode associated to the lifting of loads. Just as an example, a safety margin for lifting humans may be required to be twice the theoretically liftable load while for normal loads, a safety margin of 1.3 times the theoretically liftable load may be sufficient since damage to goods can eventually be accepted while damage to humans cannot.

Hence, according to some examples, the compute circuit limits a maximum load allowed to be lifted by the crane in the second mode as compared to the first mode. Limiting the maximum load may also comprise limiting the maximum extension of the boom 130 and/or the maximum elevation angle for a given load since one important safety aspect is also to prevent the crane from falling over which implies calculating the turning moment acting on the crane base.

According to some examples, the second mode is activated manually by user input to a control panel or to a remote control unit of the crane.

According to further examples, the second mode may also be activated automatically to prevent users from forgetting to activate the appropriate mode. Therefore, according to some examples, the input interface is optionally also configured to receive signal information indicative of the presence of an attachment at the crane, wherein the control circuitry is configured to activate the second mode in response to receipt of said signal information. For example, a sensor generating the signal information may be present at or in the vicinity of a mounting interface of the crane, the mounting interface being designed for mounting a workman basket or any other optional equipment to the crane. Sensors used for said purpose can be of various types such as for example magnetic sensors, optical sensors, proximity sensors, load sensors or sensors establishing a communication to a corresponding element at the optional equipment. For example, one or more RFID tags may be used for sensing presence of optional equipment at the mounting interface. Those examples may allow to automatically distinguish different types of optional equipment that may require different limitations of the kinematic parameters or of different subsets of the kinematic parameters of the crane. In some examples, the signal information may also be generated by user interaction, for example by operating a switch.

In other words, further examples may allow three or more operation modes of the crane, irrespective whether these are manually activated or determined automatically.

FIG. 2 illustrates an example of a crane 120 of FIG. 1, having attached thereto a workman basket 210.

The crane comprises a boom system with a single boom 130 mounted on a rotatable column 160. The crane 120 further comprises a mounting interface 220 designed for mounting the workman basket 210 at the boom system 130. While the examples described herein exhibit a single boom (stiff boom cranes), further examples of cranes may also have two or more booms. A stiff boom crane has a boom system with a single boom. Hence, while describing the examples disclosed in the figures, the terms boom system and boom may be used synonymously. Control circuitry 100 is used to control operation of the crane.

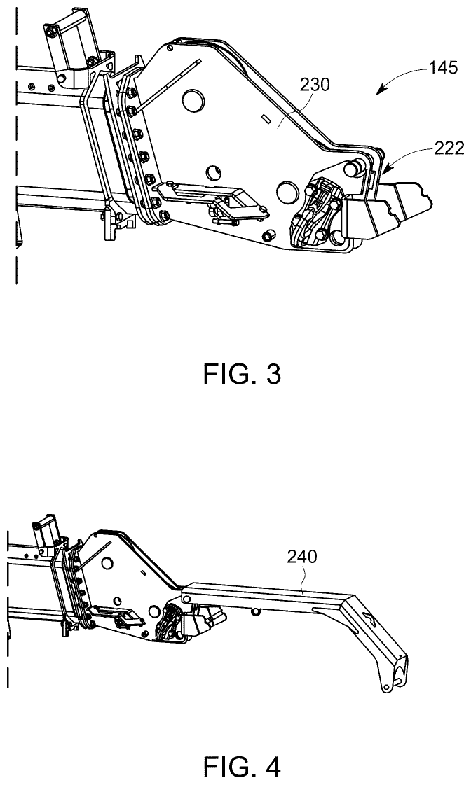

As illustrated in FIGS. 2 and 3, the mounting interface 220 may be mounted at the tip 145 of the boom system 130. According to some examples, the mounting interface may comprise a horsehead 222 welded or otherwise fixed (or mounted) to the tip 145 of the boom system 130. A horsehead is a structure that is geometrically designed such that other elements can be connected to the horsehead such that the elements are fixed to the horsehead and prevented from going loose accidentally.

FIG. 3 illustrates a magnified view of the horsehead 222 that is fixed to a standard horsehead 230 of the crane. The fixation may be performed using nuts and bolts as illustrated or using welding as mentioned before.

In the illustration of FIG. 4, the mounting interface 220 further comprises an interface portion 240 connected to the tip 145 of the boom system via the horsehead 222. The interface portion 240 is designed to connect to horsehead 222 (or e.g. welded to the horsehead 222) on one side, while the other side is designed to connect to the workman basket 210. In the disclosed example, the interface portion 240 is an additional arm carrying the workman 240 basket to prevent it from getting into contact with the boom system even if the elevation angle is high. Depending on the circumstances and the optional equipment to be attached to the booms system 130, different shapes of mounting interfaces and horseheads 222 may be used. Some equipment may be directly attached to a horsehead at the tip of the boom so that there is no interface portion present.

As elaborated on before, some examples may optionally comprise a sensor to determine presence of the workman basket mounted at the mounting interface and to generate sensor information for the control circuitry indicating the presence of the workman basket.

If the crane used is a stiff boom crane, its boom system comprises a main boom connected to the rotatable column, the main boom comprising at least one extension, wherein the mounting interface is mounted at the tip of the main boom.

If the crane used is a knuckle boom crane, its boom system comprises a main boom connected to the rotatable column, at least one further boom connected to the main boom, the at least one further boom comprising least one extension, wherein the mounting interface is mounted at the tip of the at least one further boom.

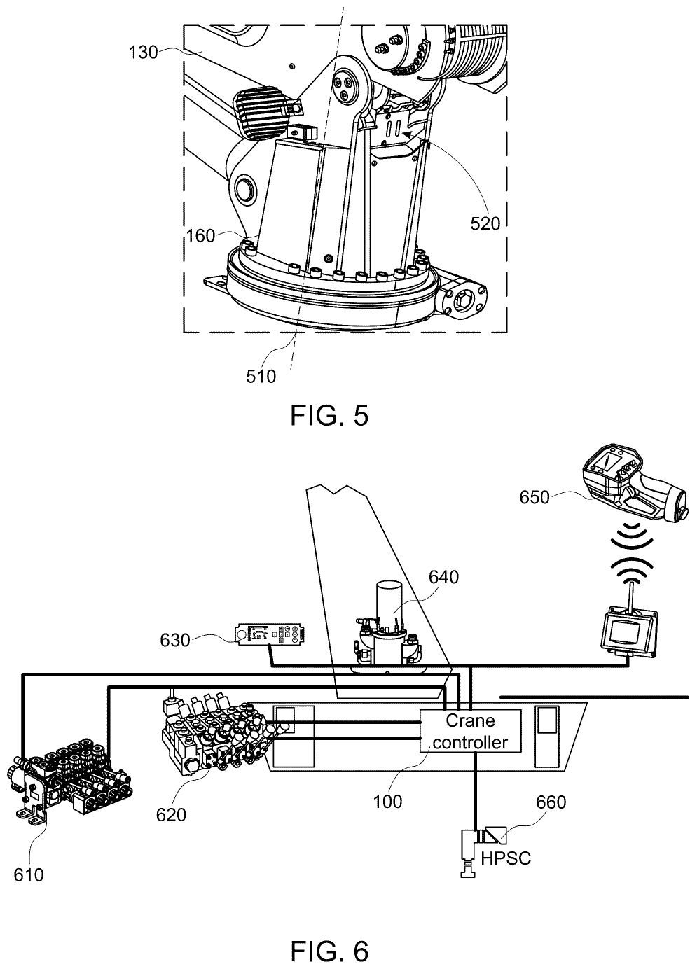

FIG. 5 illustrates a magnification of the column 160 of the crane 120.

The column 160 is rotatable about an axis 510 parallel or equal to the central axis of the cylindrical geometry of the column to change the slew angle of the crane 120. The rotation may be performed using an electric engine as an actuator.

FIG. 5. also illustrates the position of a boom extension sensor 520 within the boom 130 mounted at the column 160. The boom extension sensor 520 indicates a length extension parameter of the boom 130 that allows to conclude on the present length of the boom 130 that depends on the extent the boom extensions are driven out. For example, the boom extension sensor 520 may generate its reading using an encoded wire extending from the column 160 to the tip of the innermost extension boom. However, arbitrary other length measurement principles may be use likewise to conclude on the length of the boom.

In order to process the information on the slew angle and on the orientation of the column, some examples of control circuits may receive a sensor reading of a slew angle sensor indicating an angle of rotation of the column 160 of the crane 120. The slew angle sensor may, for example, use an encoder wheel at the base of the column to determine the angle or any other angle sensor.

Additionally or alternatively, a sensor reading of a platform tilt sensor indicating a tilting angle of the column 160 may also be processed. The platform tilt sensor generates tilt information indicating an angle between axis 510 and vertical.

FIG. 6 schematically illustrates an overview of some components involved and interacting to operate a crane as illustrated in FIGS. 1 and 2.

Control circuitry 100 (also referred to as a crane controller) comprises one or more input interfaces configured to receive readings of sensors that sense operating parameters of the crane. While the previous paragraphs give some examples of sensed parameters, it is to be noted that these examples are not exhaustive and that multiple further parameters or sensor readings may be processed by control circuitry 100.

Control circuitry 100 further comprises one or more output interfaces to output control data to cause actuators of the crane to perform a movement. Transmission and reception of the sensor readings and of the input signals and of the control data may be performed using arbitrary wired or wireless systems and data protocols. Examples of wired protocols may be Controller AreaNetwork (CAN), FlexRay, Local Interconnect Network (LIN), MOST or Ethernet. The control circuit 100 may submit digital commands as control data that need to be interpreted by the actuators before these autonomously control their movement or action or the control data may be such that the actuators are directly controlled by the control circuit 110. For example, Pulse Width Modulated signals (PWM) may be used to directly steer actuators.

Amongst the actuators controlled may be hydraulic engines 620 and 620 to control the movement of the booms of the boom system and of legs 660 extending from the base of the crane to increase its stability. Likewise, as an engine 640 used to rotate the column of the crane may be controlled by control circuitry 100.

A control panel 630 mounted at the crane and an optional remote control unit 650 communicate with the control circuitry 100. Both comprise a user interface to provide a user input for tasks and movements to be performed by the crane. For the examples described herein, at least one of the control panel 630 and the remote control unit 650 are configured to activate at least the first operation mode and the second operation mode of the crane, wherein at least one kinematic parameter of the actuators is limited in the second mode as compared to the first mode.

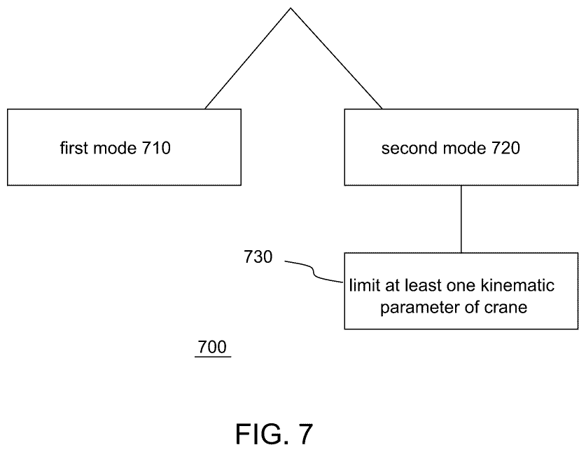

FIG. 7 illustrates a flowchart of an example of a method to operate a crane 700.

The method comprises activating a first operation mode 710 or a second operation mode 720 to control movement of actuators of the crane; and
limiting at least one kinematic parameter 730 of the actuators in the second mode as compared to the first mode.

In the following, some examples of the proposed concept are presented:

An example (e.g., example 1) relates to control circuitry for a crane, comprising an input interface (102) configured to receive readings of sensors (174, 520) sensing operating parameters of the crane, an output interface (104) to output control data to cause actuators of the crane to perform a movement, and a compute circuit (106) configured to control the movement of the actuators in a first operation mode and in a second operation mode, wherein at least one kinematic parameter of the actuators is limited in the second mode as compared to the first mode.

Another example (e.g., example 2) relates to a previous example (e.g., example 1) or to any other example, further comprising that the at least one kinematic parameter comprises at least one of a maximum speed, a reference acceleration, a reference deceleration, a maximum extension, a maximum rotation, a lifting capacity and a functionality.

Another example (e.g., example 3) relates to a previous example (e.g., one of the examples 1 or 2) or to any other example, further comprising that the compute circuit (106) limits a maximum load allowed to be lifted by the crane in the second mode as compared to the first mode.

Another example (e.g., example 4) relates to a previous example (e.g., one of the examples 1 to 3) or to any other example, further comprising that the input interface (102) is configured to receive signal (174, 520) information indicative of the presence of an attachment at the crane, wherein the control circuitry (100) is configured to activate the second mode in response to receipt of said sensor (174, 520) information.

Another example (e.g., example 5) relates to a previous example (e.g., example 4) or to any other example, further comprising that the attachment is a workman basket (210).

Another example (e.g., example 6) relates to a previous example (e.g., one of the examples 1 to 5) or to any other example, further comprising that the control circuitry (100) is configured to control the movement of a crane having a single boom.

An example (e.g., example 7) relates to a crane, comprising a boom system (130) mounted on a rotatable column (160), a mounting interface (220) designed for mounting a workman basket (210) at the boom system (130), and control circuitry (100) according to any one of examples 1 to 6.

Another example (e.g., example 8) relates to a previous example (e.g., example 7) or to any other example, further comprising that the mounting interface (220) is mounted at a tip (145) of the boom system (130).

Another example (e.g., example 9) relates to a previous example (e.g., example 8) or to any other example, further comprising that the mounting interface (220) comprises a horse-head (222, 230) mounted or welded to the tip (145) of the boom system (130).

Another example (e.g., example 10) relates to a previous example (e.g., one of the examples 8 or 9) or to any other example, further comprising that the mounting interface (220) comprises one or more interface portions connected to the tip (145) of the boom system (130).

Another example (e.g., example 11) relates to a previous example (e.g., one of the examples 8 or 9) or to any other example, further comprising that the mounting interface (220) comprises a horsehead portion mounted or welded to the tip (145) of the boom system (130) and an interface module connected to the horsehead portion.

Another example (e.g., example 12) relates to a previous example (e.g., one of the examples 7 to 11) or to any other example, further comprising a sensor (174, 520) to determine presence of the workman basket (210) mounted at the mounting interface (220) and to generate sensor (174, 520) information for the control circuitry (100) indicating the presence of the workman basket (210).

Another example (e.g., example 13) relates to a previous example (e.g., one of the examples 7 to 12) or to any other example, further comprising that the boom system (130) comprises a main boom connected to the rotatable column (160), the main boom comprising at least one extension, wherein the mounting interface (220) is mounted at the tip (145) of the main boom.

An example (e.g., example 14) relates to the crane of any one of 7 to 12, wherein the boom system (130) comprises a main boom connected to the rotatable column (160), at least one further boom connected to the main boom, the at least one further boom comprising least one extension, wherein the mounting interface (220) is mounted at the tip (145) of the at least one further boom.

An example (e.g., example 15) relates to a remote control unit (650) to wirelessly interact with control circuitry (100) of a crane to cause the control circuitry (100) to control the movement of actuators of the crane, and the remote control unit (650) comprising a user interface configured to activate at least a first operation mode and a second operation mode of the crane, wherein at least one kinematic parameter of the actuators is limited in the second mode as compared to the first mode.

An example (e.g., example 16) relates to a method to operate a crane, comprising activating a first operation mode (710) or a second operation mode (720) to control movement of actuators of the crane, and limiting at least one kinematic parameter (730) of the actuators in the second mode as compared to the first mode.

Another example (e.g., example 17) relates to a computer program having program code causing performing the method of example 16, if the program is executed by control circuitry (100) of a crane.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. Control circuitry for a crane, comprising:
an input interface (102) configured to receive readings of sensors (174, 520) sensing operating parameters of the crane;
an output interface (104) to output control data to cause actuators of the crane to perform a movement; and
a compute circuit (106) configured to control the movement of the actuators in a first operation mode and in a second operation mode, wherein at least one kinematic parameter of the actuators is limited in the second mode as compared to the first mode.

2. Control circuitry according to claim 1, wherein the at least one kinematic parameter comprises at least one of: a maximum speed, a reference acceleration, a reference deceleration, a maximum extension, a maximum rotation, a lifting capacity and a functionality.

3. Control circuitry according to claim 1, wherein the compute circuit (106) limits a maximum load allowed to be lifted by the crane in the second mode as compared to the first mode.

4. Control circuitry according to claim 1, wherein the input interface (102) is configured to receive signal (174, 520) information indicative of the presence of an attachment at the crane, wherein the control circuitry (100) is configured to activate the second mode in response to receipt of said signal (174, 520) information.

5. Control circuitry according to claim 4, wherein the attachment is a workman basket (210).

6. Control circuitry according to claim 1, wherein the control circuitry (100) is configured to control the movement of a crane having a single boom.

7. A crane, comprising:
a boom system (130) mounted on a rotatable column (160);
a mounting interface (220) designed for mounting a workman basket (210) at the boom system (130); and
control circuitry (100) according to claim 1.

8. The crane of claim 7, wherein the mounting interface (220) is mounted at a tip (145) of the boom system (130).

9. The crane of claim 8, wherein the mounting interface (220) comprises a horsehead (222, 230) mounted to the tip (145) of the boom system (130).

10. The crane of claim 8, wherein the mounting interface (220) comprises one or more interface portions connected to the tip (145) of the boom system (130).

11. The crane of claim 8, wherein the mounting interface (220) comprises a horsehead portion mounted to the tip (145) of the boom system (130) and an interface module connected to the horsehead portion.

12. The crane of claim 7, further comprising:
a sensor (174, 520) to determine presence of the workman basket (210) mounted at the mounting interface (220) and to generate sensor (174, 520) information for the control circuitry (100) indicating the presence of the workman basket (210).

13. The crane of claim 7, wherein the boom system (130) comprises a main boom connected to the rotatable column (160), the main boom comprising at least one extension, wherein the mounting interface (220) is mounted at the tip (145) of the main boom.

14. The crane of claim 7, wherein the boom system (130) comprises a main boom connected to the rotatable column (160), at least one further boom connected to the main boom, the at least one further boom comprising least one extension, wherein the mounting interface (220) is mounted at the tip (145) of the at least one further boom.

15. A method to operate a crane, comprising:
activating a first operation mode (710) or a second operation mode (720) to control movement of actuators of the crane; and
limiting at least one kinematic parameter (730) of the actuators in the second mode as compared to the first mode.
